(19) United States
(12) Patent Application Publication
(10) Pub. No.: US 2004/0089358 A1
(43) Pub. Date: May 13, 2004

(54) Lining of pipes

(76) Inventors: John Ferris Burd, West Bridgford (GB); Roger Philip Ashworth, Loughborough (GB); Stephen Robert Delaforce, Loughborough (GB)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/466,215

(22) PCT Filed: Jan. 10, 2002
(86) PCT No.: PCT/GB02/00100

(30) Foreign Application Priority Data
Jan. 12, 2001 (GB) 0100876.2

(51) Int. Cl. F16L 55/16

(52) U.S. Cl. 138/98; 264/269

(57) ABSTRACT

A method of lining a main pipe and one or more service pipes extending therefrom is disclosed. The method comprises lining a main pipe with a liner of plastics material, inserting a liner of plastics material into a service pipe from an end of the service pipe remote form the main pipe and penetrating the wall of the main pipe liner to bring the main pipe into fluid communication with the service pipe. The wall of the main pipe liner is preferably penetrated by providing a pig or robot inside the lined main pipe, locating the position at which a service pipe is joined to the main pipe and using the pig or robot to cut, drill or pierce through the wall of the main pipe liner. A further lining portion may be provided along at least a part of any distance between the main pipe liner and the liner inserted into the service pipe. The further lining portion may be an insert of plastics material or may be provided by sealant with a channel formed therein or it may be formed by a combination of the two. Alternatively, the further lining portion may be provided some other way such as by extruding a portion of the main pipe liner outwards. A joint such as a so-called Tee joint may be provided between the main pipe and a service pipe.

The present invention relates to the lining of main pipes and service pipes extending therefrom. Such pipes may be used to supply a commodity such as gas or water to consumers.

Main pipes, which may for example extend along a street, may have several service pipes branching off to supply a number of users' premises. Main pipes and service pipes are generally made from metal such as steel and it is often desirable to line the metal pipes to reduce the risk of corrosion and leaks. This is generally done by first lining the main pipe with a liner of plastics material by any method well know in the art. A favoured method of lining pipes known by the registered trade mark “SWAGELINING” involves making an excavation at convenient spaced portions of the main pipe, pulling a liner of plastics material through a die to temporarily reduce its diameter, pulling the liner through the main pipe from one excavation to the other and allowing the liner to expand to its previous diameter, preferably to line the main pipe closely. The joint between the main pipe and service pipe is then excavated and a liner of plastic material inserted into the service pipe from the excavated joint. However, digging an excavation to line each service pipe is a time consuming, disruptive and expensive task.

According to a first aspect of the present invention, there is provided a method of lining a main pipe and one or more service pipes extending therefrom, the method comprising lining a main pipe with a liner of plastics material, inserting a liner of plastics material into a service pipe from the end of the service pipe remote from the main pipe and penetrating the wall of the main pipe liner to bring the main pipe into fluid communication with the service pipe.

By inserting the liner into the service pipe from the end of the service pipe remote from the mains pipe, there is no need to make an excavation at the joint between the main pipe and the service pipe thus reducing disruption, installation time and installation costs.

The wall of the main pipe liner is preferably penetrated by providing a pig, robot or other remotely operated device inside the lined main pipe, locating the position at which a service pipe branches off from the main pipe and using the pig, robot or other remotely operated device to penetrate through the main pipe liner. The position at which a service pipe branches off from the main pipe may be located by the pig, robot or other remotely operated device in the main pipe detecting a signal transmitted along or from within the service pipe. The signal may be an electromagnetic signal but is preferably an acoustic signal which can be generated and detected using less expensive equipment. Furthermore, an acoustic signal can be directed down the service pipe using the service pipe as a waveguide. The pig, robot or other remotely operated device preferably cuts or drills through the wall of the main pipe liner, but it could pierce, melt or force its way through the wall of the main pipe liner.

The joint between the main pipe and the service pipe is preferably provided by a so called “Tee” which conveniently enables a branch from the main pipe to extend substantially from the top of the mains pipe and then substantially horizontally towards a user's premises.

If desired, the wall of the mains pipe liner could be penetrated by excavating down to the Tee, preferably providing so called keyhole access which provides a relatively narrow excavation, and drilling from the Tee through the main pipe liner wall.

Preferably, a further lining portion is provided along at least a portion of any distance between the liner of the main pipe and the liner inserted into the service pipe. This further lining portion is preferably inserted from a pig, robot or other remotely operated device in the main pipe. Alternatively, the further lining portion could be provided on an end of the liner inserted into the service pipe. Alternatively, the further lining portion could be provided by inserting sealant or grout between the main pipe liner and the liner inserted into the service pipe and by drilling or cutting through the sealant or grout to form the further lining portion. If desired, a plastics further lining portion could be inserted from the main pipe and sealant or grout inserted between the main pipe liner and the service pipe liner and drilling or cutting through the set sealant or grout if necessary. Alternatively, the further lining portion could be provided by extruding a portion of the main pipe liner outwards into the service pipe or joint.

A further liner portion inserted from the main pipe or service pipe may be secured to the inside of the main pipe, preferably by a fusion joint to a polymer liner inside the main pipe. The liner inserted into the service pipe may be inserted from where the service pipe reaches a user's premises, for example, where the service pipe would be joined to a meter.

The service pipe liner portion and any further lining portion, which may be inserted from opposite ends of the service pipe, may be joined to each other by for example one fitting inside the other or by a fusion joint. The service pipe liner and any further lining portion may be held adjacent to each other by surrounding the adjacent portions with grout.

Examples of methods of performing the present invention will now be described with reference to the accompanying drawings in which:—

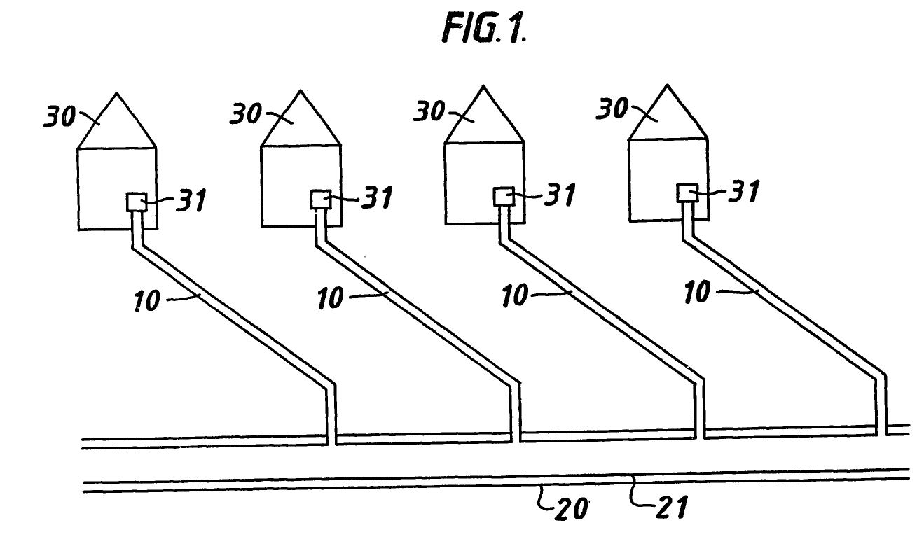

FIG. 1 shows a number of service pipes connected between user's premises and a main pipe;

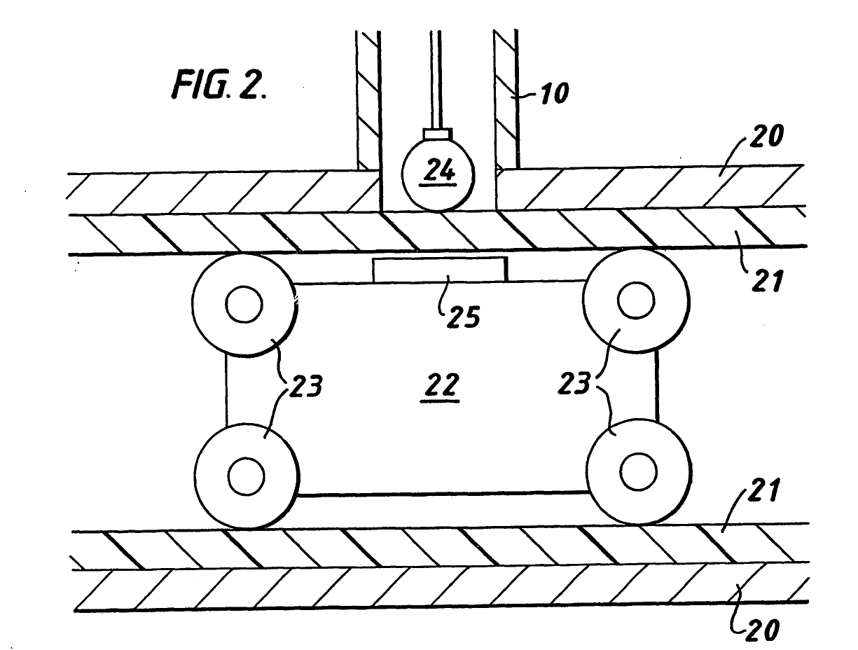

FIG. 2 shows a pig, robot or other remotely operated device inside a lined main pipe;

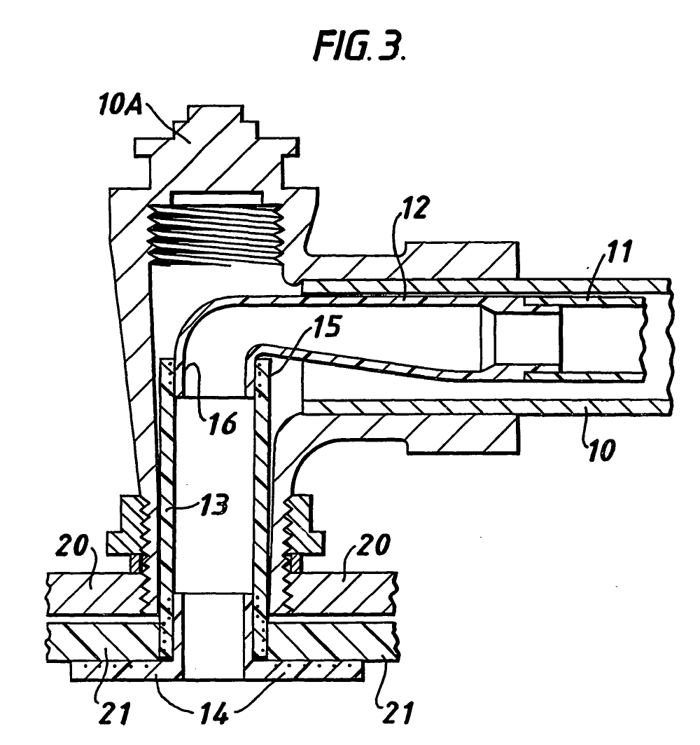

FIGS. 3 to 10 show various examples of lining a main pipe and a service pipe; and

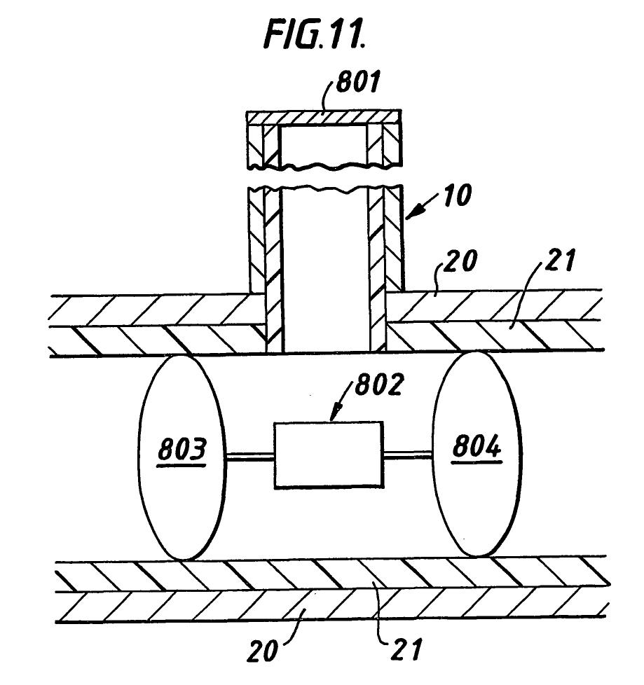

FIG. 11 shows a device for pressure testing the lined joint between a service pipe and a main pipe.

FIG. 1 shows a number of service pipes 10 connected between a main pipe 20 and user's premises 30. In this example, each service pipe 10 is connected to a user's premises 30 through a meter 31.

The main pipe 20 is generally made of metal, in this case cast iron. Metal main pipes, as in this case, are generally lined with a polymer liner 21 such as polyethylene for renovation purposes. A main pipe 20 is often lined just before adjoining service pipes 10 are lined. A main 20 is generally lined by making an excavation at both ends of a suitable length of main pipe 20 and pulling a suitable length of polymer liner 21 therethrough as is well known in the art.

A pig, robot or other remotely operated device 22 with wheels 23 or tracks as shown in FIG. 2 then enters the lined main pipe 20 and locates the positions at which the service pipes 10 to be lined join the main pipe 20. Location of the positions at which the service pipes 10 to be lined join the main pipe 20 can be done in a number of ways. For example, a transmitter 24 may be passed from an open end of the service pipe 10, e.g. from an end of the service pipe disconnected from a meter 31, until it reaches the outside of the liner 21 of the main pipe 20. The pig, robot or other remotely operated device will be provided with a sensor 25 to detect the transmitted signal from the service pipe 10; Electromagnetic transmitters 24 and electromagnetic sensors 25 are known but the use of an acoustic transmitter 24 such as a speaker within the service pipe or to direct an acoustic signal along the service pipe and an acoustic sensor 25 such as a microphone are considered unique and a further aspect of the present invention.

Once the pig, robot or other remotely operated device 22 has detected the position where the service pipe 10 joins the main pipe 20, it may activate a cutter or drill (not shown) to cut through the liner pipe 21 at the appropriate joint so that the main pipe 20 is in fluid communication with the service pipe 10. Alternatively a narrow or so-called “key hole” excavation may be made down to the joint between the main pipe and the service pipe and a drill inserted down the “key hole” excavation to drill through the wall of the main pipe liner.

A liner portion may be inserted from an open end of the service pipe 10 before or after the liner of the main pipe is penetrated. A further lining portion may be provided along at least a portion of any distance between the liner of the main pipe and the liner inserted into the service pipe as described in the following examples.

A first example of lining main and service pipes is shown in FIG. 3. First a cast iron main pipe 20 is lined with a polyethylene liner 21. A liner portion 11 is inserted from an open end of the service pipe 10. This liner portion 11 is provided with a tapered front end portion 12 which is fusion welded onto liner portion 11 before insertion. Liner portion 11 is inserted along the service pipe 10 until the tapered portion 12 reaches a suitable position for attachment to another liner portion 13 to be inserted from the main pipe 20. In this example, the service pipe 10 is provided with a Tee Joint 10A for attaching the service pipe 10 to the main pipe 20. A second liner portion 13 is inserted from main pipe 20 using a pig, robot or other remotely operated device after it has identified where the service pipe branches off from the main pipe 20 and penetrated through the liner 21 of the main pipe 20 at the identified location, in this case using a drill. The second liner portion 13 is fusion welded to the polymer liner pipe 21 and in this case, a polymer bracket 14 is fusion welded around the joint between the liner portion 13 and polymer liner pipe 21 to increase the strength of the join. The second liner portion 13 and the bracket 14 could be provided as a single element. Inserting liner portion 13 positions its front end 15 around the front end 16 of tapered front end portion 12. The two liner portions 15,16 are then electrofusion welded together to enable fluid to pass along both liner portions from the main pipe 20 to the service pipe 10.

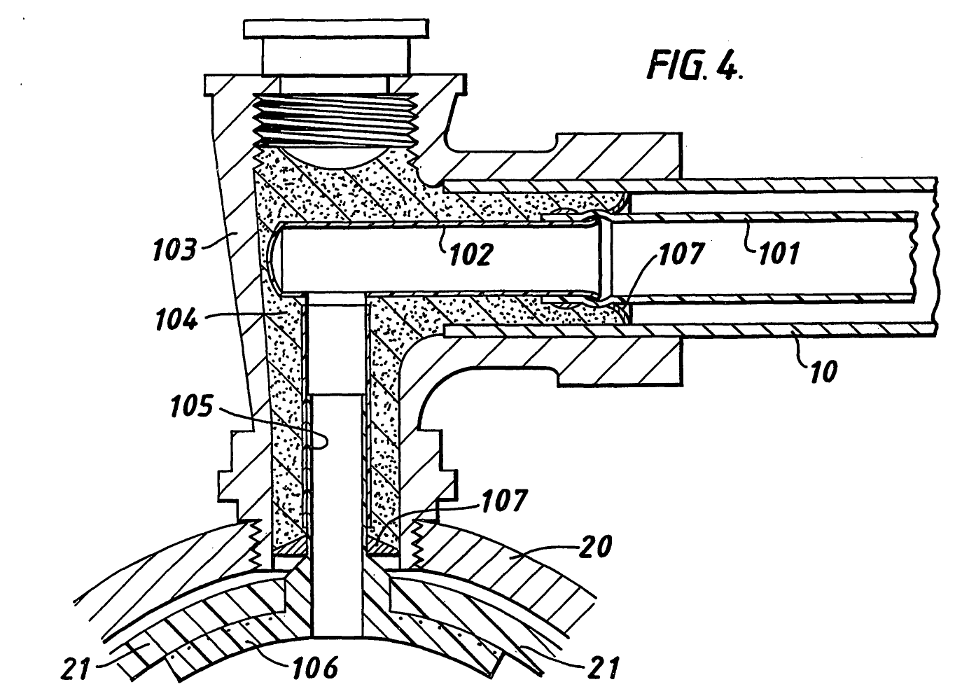

FIG. 4 shows a second example of lining a main pipe and a service pipe according to the first aspect to the present invention. In this example, after lining cast iron main pipe 20 with a polyethylene liner 21, a liner portion 101 with a prior connected front end portion 102 is inserted into an open end of the service pipe 10 until it reaches the Tee joint 103 connecting the service pipe 10 to the main pipe 20. A fixed amount of grout 104 is inserted into the inside of the Tee joint 103 surrounding the front end portion 102 of the liner portion 101. The grout 104 maybe inserted by any convenient method such as from a pig, robot or other remotely operated device in the main pipe 20 or from an insertion tube to be passed along liner portion 101. When the grout has set a pig, robot or other remotely operated device (not shown) in the main pipe 20 drills through the grout and into the front end portion 102 of the liner portion 101 so that the liner portion 101 is in fluid communication with the main pipe 20. If desired, a second liner portion 105, which in this case is telescopic, may be inserted from a pig or robot in the main pipe 20 to line the channel cut through the grout 104 from the main pipe 20 to the front end portion 102. The second liner portion 105 has a collar 106 at its lower end which is fusion joined to the polymer pipe 21 lining the main pipe 20. If desired annular seals 107 may be provided to prevent the grout 104 from extending too far along the service pipe 10 or into the main pipe 20.

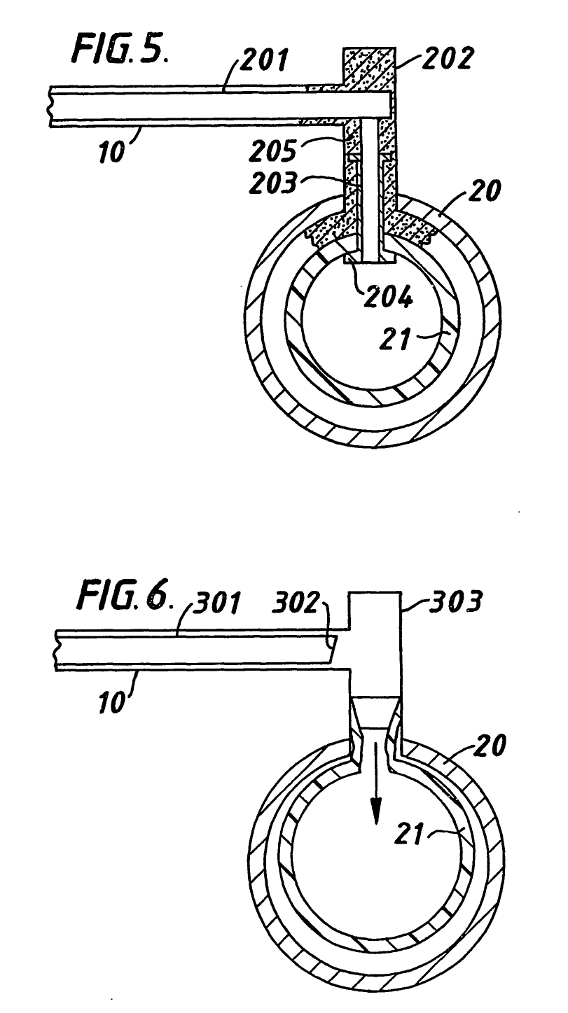

FIG. 5 shows a third example of the present invention. Main pipe 20 is lined with a polyethylene liner 21 and steel service pipe 10 is lined with a polyethylene liner 201 as far as the Tee 202. A pig, robot or other remotely operated device is then inserted into the lined main pipe and locates the point at which the service pipe 10 or Tee 202 branches off from the main pipe and drills through the liner 21 of the main pipe 20 at that point. The pig, robot or other remotely operated device then introduces an insert 203 through the drilled hole of the mains liner 21 into the Tee 202. The insert 203 does not reach as far as the service pipe liner 201. The insert 203 is attached to the main pipe liner 21 by any suitable means such as by bonding or welding a flange 204 of the insert to the main pipe liner 21. This is performed by the pig, robot or other remotely operated device. The pig, robot or other remotely operated device then inserts grout or sealant 205 into the region of the Tee 202 between the service pipe liner 201 and the insert 203. After the grout or sealant 205 has set, the pig, robot or other remotely operated device drills up from the main 20, through the insert 203, the set grout or sealant 205 and the wall of the service pipe liner 201 to provide a fluid path from the lined main 20 to the liner 201 of the service pipe 10 via the insert 203 and the grouted pathway 205.

FIG. 6 shows a fourth example of the present invention. This example is applicable for when the Tee joint 303 is in serviceable condition and the service pipe does not necessarily require renovation or lining. In this example, main pipe 20 is lined with a polyethylene liner 21. Steel service pipe 10 may be lined with a plastic liner 301 but this is not essential. In this example, plastic liner 301 is inserted such that it is not blocked by being pushed against the inside face of top Tee 302. This may be achieved by ensuring that the end of the service pipe liner 301 is spaced some distance from the inside surface of Tee 303 and/or by cutting the end face 302 of service pipe line 301 so that it is not able to seal against the inside surface of the Tee 303 because it is at some angle to the perpendicular of the axis of the service pipe liner 301. A pig, robot or other remotely operated device is then inserted into the lined main pipe and locates the point at which the service pipe 10 or Tee 303 branches off from the main pipe 20. The pig, robot or other remotely operated device then heats the portion of liner 21 at that location and extrudes that portion of heated liner 21 into the bore of the Tee 303. The pig, robot or other remotely operated device then pierces the wall of the extruded section of liner 21 and passes an expanding tapered mandrel 304 through the pierced wall of the liner 21. The mandrel is then expanded and pulled down from the Tee 303 back to the main pipe 20 to push the extruded section of the liner 21 against the inside walls of the Tee 303. Alternatively, the mandrel 304 could be inserted from the main pipe 20 into the Tee 303 in its expanded condition to push the extruded section of the liner 21 against the inside walls of the Tee 303, the mandrel is then contracted and then retracted back to the pig, robot or other remotely operated device.

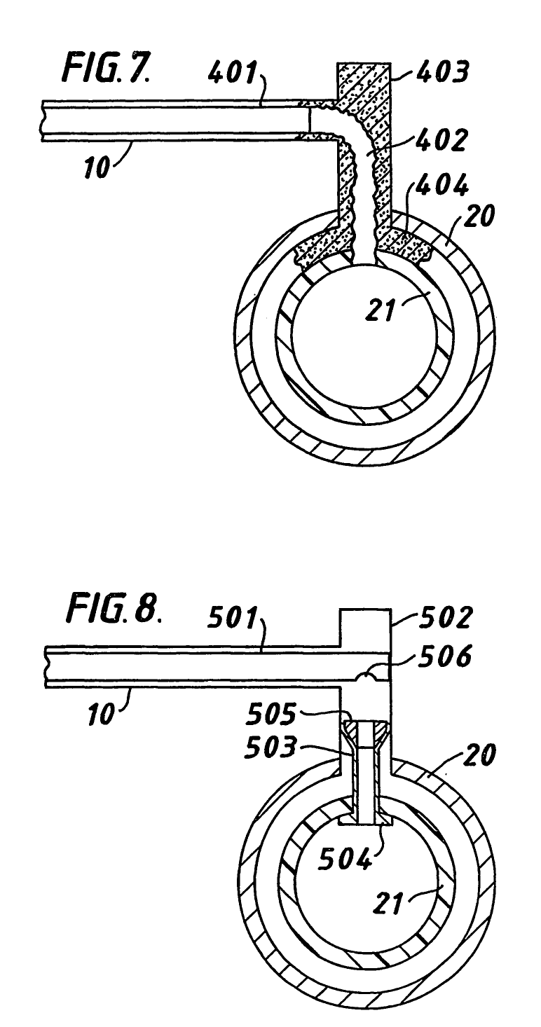

FIG. 7 shows a fifth example of the present invention. As in previous examples, main pipe 20 is lined with a polyethylene liner 21. Service pipe 10 is lined with a liner 401 which in this case has a flexible section of further liner material 402, in this example known as serviflex, at the end nearest to the main pipe 20. A pig, robot or other remotely operated device is inserted into the lined main pipe and locates the point at which the service pipe 10 or Tee 403 branches off from the main pipe 20. The pig, robot or other remotely operated device then cuts or drills a hole through the main pipe liner at that point and the flexible section of further liner material 402 is fed into the main 20. The flexible section of further liner material 402 is grouted into position by grout 404 supplied by any convenient method such as by an insertion tube to be passed down the service pipe 10.

FIG. 8 shows a sixth example of the present invention. The main pipe 20 is lined with a polyethylene liner 21 and service pipe 10 is lined with a liner 501. A pig, robot or other remotely operated device is inserted into the lined main pipe and locates the point at which a service pipe 10 or Tee 502 branches off from the main pipe and drills through the liner 21 of the main pipe 20 at that point. The pig, robot or other remotely operated device then introduces an insert 503 through the drilled hole of the liner 21 and into the Tee 502. The insert 503 is attached to the main pipe liner 21 by any suitable means such as by bonding or welding a flange 504 of the insert 503 to the main pipe liner 21. This is performed by the pig, robot or other remotely operated device. The pig, robot or other remotely operated device then introduces an expanding mandrel 505 into the insert 503 and expands the mandrel 505 to seal the insert against the inner wall of the Tee 502. The mandrel 505 is left in-situ and has an opening for the passage of gas when in use. The service pipe liner 501 is provided with a hole 506 through which fluid may pass into the service pipe from the Tee 502. The hole 506 may be provided before the service liner 501 is inserted into the service pipe 10 or it may be drilled from a pig or robot within the main pipe 20 which could insert sealant or grout before drilling. Alternatively the entrance to the service pipe liner could be spaced from the inner surface of the Tee to permit access of fluids from the Tee 502.

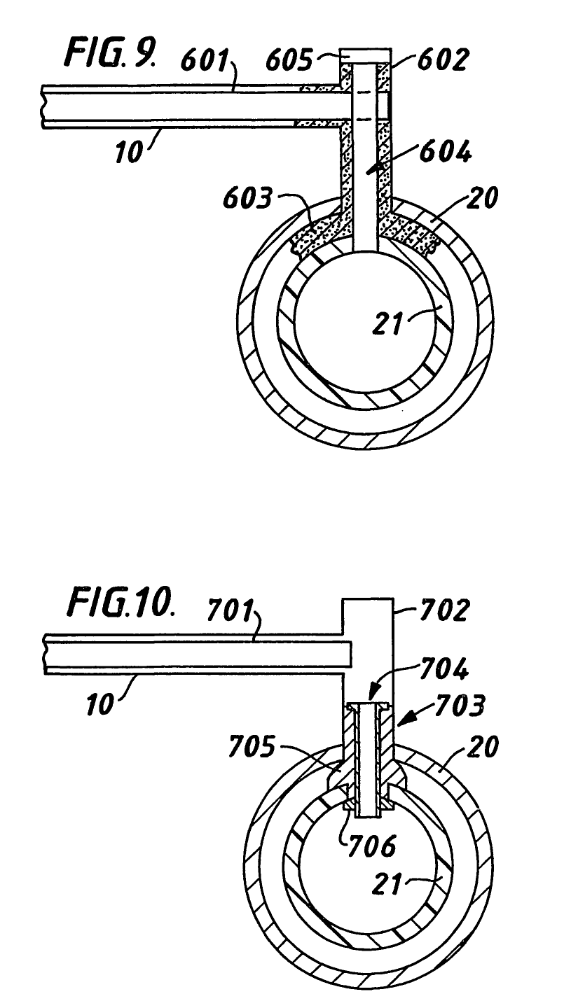

FIG. 9 shows a seventh example of the present invention. The main pipe 20 is lined with a polyethylene liner 21 and the service pipe 10 is lined with a liner 601. A narrow or so-called “key hole” excavation is made above the joint or Tee 602 between the main pipe 20 and service pipe 10. Using suitable key hole access tools are as well known in the art the top of the Tee 602 is drilled to provide access to a device to inject sealant or grout 603 into the Tee 602. The sealant or grout 603 is allowed to cure and is then drilled from above, again using suitable key hole tooling, through between the service pipe liner 601 and the main pipe liner 21 to provide a passage 604. The Tee 602 is then sealed with a cap 605.

FIG. 10 shows an eighth example of the present invention. Main pipe 20 is lined with a polyethylene liner 21 and steel service pipe 10 is lined with a polyethylene liner 701. An end of polyethylene liner 701 is spaced from the inner surface of Tee 702 to enable fluid to pass from the Tee 702 into the service pipe liner 701. A pig, robot or other remotely operated device is inserted into the lined main pipe and locates the point at which the service pipe 10 or Tee 702 branches off from the main pipe 20 and drills through the main pipe liner 21 at that point. The pig, robot or other remotely operated device then introduces an insert 703 into the Tee 702. The insert 703 has an internal passage 704 along its length extending in use from the lined main pipe 20 to the Tee 702 and carries compressible material 705 with a bonding agent. The pig, robot or other remotely operated device then screws a nut 706 onto an end of the insert 703 to compress the compressible material 705 by the action of the nut against the inside surface of the main pipe liner 21. The compressible material 705 expands outwards into engagement with the inside surface of the Tee 702 and is fixed into position by a bonding agent which is released upon compression.

Once the main pipe 20 and liner pipe 10 have been lined, a pressure test may be performed as illustrated in FIG. 11 to check that there are no leaks. The service pipe 10 or Tee is blocked 801 at a suitable point and a pig, robot or other remotely operated device 802 is inserted into the main pipe 20 to where the service pipe 10 joins the main pipe 20. The pig, robot or other remotely operated device 802 forms a seal around the joint between the main pipe 20 and the service pipe 10, in this case using two inflatable seals 803, 804 within the main pipe. The pig, robot or other remotely operated device increases the pressure in the volume between 801 and the seals 803, 804 to a predetermined value and determines whether there is a leak by monitoring the rate of reduction of pressure in the volume. If desired, the pig, robot or other remotely operated device 802 may insert a mechanical device up the service pipe 10 from its position in the main pipe 10 and agitate the inside of the service pipe 20 to ensure that the lining does not have any leaks even when mechanically agitated.

1. A method of lining a main pipe and one or more service pipes extending therefrom, the method comprising:—
lining a main pipe with a liner of plastics material;
inserting a liner of plastics material into a service pipe from an end of the service pipe remote from the main pipe; and
penetrating the wall of the main pipe liner to bring the main pipe into fluid communication with the service pipe.

2. A method according to claim 1, wherein the wall of the main pipe liner is penetrated by providing a pig, robot or other remotely operated device inside the lined main pipe, locating the position at which a service pipe is joined to the main pipe and using the pig, robot or other remotely operated device to penetrate through the main pipe liner at that position.

3. A method according to claim 2, wherein the position at which a service pipe is joined to the main pipe is located by the pig, robot or other remotely operated device in the main pipe detecting a signal transmitted from or along the service pipe.

4. A method according to claim 3, wherein the signal that is transmitted from or along the service pipe for detection by the pig, robot or other remotely operated device in the main pipe is an acoustic signal.

5. A method according to any of claims 2 to 4, wherein the pig, robot or other remotely operated device cuts through the main pipe liner.

6. A method according to any of claims 2 to 4, wherein the pig, robot or other remotely operated device drills through the main pipe liner.

7. A method according to any of claims 2 to 4, wherein the pig, robot or other remotely operated device pierces through the main pipe liner.

8. A method according to any of the preceding claims, wherein a further lining portion is provided along at least a portion of any distance between the main pipe liner and the liner inserted into the service pipe.

9. A method according to claim 8 when dependent upon claim 7, wherein the pig, robot or other remotely operated device heats the main pipe liner and extrudes the heated portion outwards prior to piercing the heating portion.

10. A method according to claim 8 when dependent upon claim 2, wherein the further lining portion is inserted from the pig, robot or other remotely operated device inside the main pipe.

11. A method according to claim 10, wherein the further lining portion is made from plastics material and electrofusion welded to the main pipe liner.

12. A method according to claim 10 or 11, wherein an end of the further lining portion interlocks with the service pipe liner.

13. A method according to claim 12, wherein the interlocking ends of the further lining portion and the service pipe liner are electrofusion welded together.

14. A method according to any of claims 10 to 13, wherein sealant is provided around the end portions of the further lining portion and the service pipe liner that are closest to each other.

15. A method according to claim 14, wherein after the sealant has set, the pig, robot or other remotely operated device penetrates through the set sealant to bring the main pipe liner into fluid communication with the service pipe liner via the further lining portion and any sealant between the service pipe liner and the further lining portion.

16. A method according to any of claims 8 to 11, wherein an expanding mandrel is provided in the further lining portion to compress the further lining portion against a surrounding wall, the expanded mandrel being arranged to enable fluid to pass therethrough.

17. A method according to any of claims 8 to 11, wherein the further lining portion is provided with compressible material which when activated expands outwards into engagement with a surrounding wall.

18. A method according to claim 8, wherein the further lining portion is flexible and is attached to and inserted into the service pipe with the service pipe liner and when inserted is held in place between the service pipe liner and the main pipe liner by being surrounded by sealant.

19. A method according to claim 8 or claim 10, wherein the further lining portion is provided by sealant provided between the service pipe liner and the main pipe liner and drilling or cutting through the set sealant to form a passage between the service pipe liner and main pipe liner.

20. A method according to claim 19, wherein a keyhole excavation is provided from above ground through which sealant is provided to be delivered between the service pipe liner and the main pipe liner.

21. A method according to any of the preceding claims, wherein a joint is provided between the main pipe and the service pipe.

22. A method according to claim 21, wherein the joint is a Tee joint.

23. A method according to any of the preceding claims, wherein the lining of the main and service pipes is tested to ensure that there are no leaks.

24. A method of lining a main pipe and one or more service pipes extending therefrom substantially as hereinbefore described with reference to the accompanying drawings.

25. A main pipe and service pipe lined by the method according to any of the preceding claims.
